(19) United States
(12) Patent Application Publication
(10) Pub. No.: US 2013/0056454 A1
(43) Pub. Date: Mar. 7, 2013

(54) APPARATUS AND METHODS FOR REDUCING THE AMBIENT MAGNETIC FIELD STRENGTH TO FACILITATE ARC WELDING

(71) Applicants: Stephen Anthony Lawrence Foulds, Cambridge (GB); John Douglas Anderson, Cambridge (GB)

(72) Inventors: Stephen Anthony Lawrence Foulds, Cambridge (GB); John Douglas Anderson, Cambridge (GB)

(73) Assignee: DIVERSE TECHNOLOGIES AND SYSTEMS LIMITED, Shelford Cambridge Cambridgeshire (GB)

(21) Appl. No.: 13/642,668

(22) PCT Filed: Apr. 20, 2011
(86) PCT No.: PCT/GB11/50785

§ 371 Date: Nov. 9, 2012

(30) Foreign Application Priority Data
Apr. 21, 2010 (GB) 1006656.1
Nov. 25, 2010 (GB) 1019979.2

(51) Int. Cl. B23K 9/08

(52) U.S. Cl. 219/137 PS; 219/136

(57) ABSTRACT

Apparatus for reducing the strength of an ambient magnetic field in a weld region comprises a magnetic field generator (50, 52, 54, 56) for generating an opposing magnetic field in the weld region in response to an input current, a magnetic field sensor (140) for sensing the direction and the magnitude of an ambient magnetic field in any vector direction in the weld region and outputting a sensor signal in response thereto, and a controller (7) arranged to receive the sensor signal and control the input current to the magnetic field generator in response to the sensor signal so as to generate the opposing magnetic field which reduces the magnetic field in the weld region. Methods for reducing the magnetic field in a weld region using apparatus of this form are also provided.

### FIELD OF THE INVENTION

The present invention relates to the creation of low magnetic field zones in a high ambient magnetic field to facilitate arc and charged particle welding.

### BACKGROUND OF THE INVENTION

Arc welding techniques are affected by magnetic fields and weld quality suffers when high magnetic fields are present. For example magnetic fields over 0.005 Tesla are typically problematic for manual metal arc welding and a process known as arc wander occurs. In higher fields the arc becomes unstable resulting in a process known as arc blow.

Industrial processes to extract metals such as zinc and aluminium employ large smelting currents, typically 350,000 Amps. In such environments the magnetic fields local to the bars carrying such currents are 0.2 Tesla or more. For practical reasons it is not possible to turn off the smelting current so welding has to take place in the high magnetic field. Welding repair work in such an environment is routinely required but is very difficult to achieve due to the high magnetic field strengths. The result is an unstable arc causing low quality welds. The arc has a very low mass so the force on it as a result of the interaction of the local magnetic field and the weld current produces high acceleration resulting in rapid extinction of the arc.

Arc instability in magnetic fields is a known problem. Routinely it is arises in the welding of magnetic materials such as pipes and plates. Such materials become magnetised and magnetic field becomes concentrated in the air gap of weld preparations. Several methods exist for solving this problem. One involves demagnetising the magnetic parts by either passing them through an a.c. excited coil or by applying a large magnetic field that changes sign and gradually reduces in magnitude. However, such demagnetizers are large and the process is slow. A more practical method is to negate the magnetic field at the position of welding after Blakeley U.S. Pat. No. 4,761,536. This method uses a Hall device to monitor the magnetic field at the weld position and control of current to coils to balance the magnetic field at the weld position. U.S. Pat. No. 6,617,547 after Abdurachmanov provides a method to negate the magnetic field similar to Blakeley except there is no direct measure of magnetic field. Abdurachmanov provides an optical feedback method to drive current into coils to ensure that the arc remains orthogonal to the workpiece.

In high field smelting environments ferromagnetic material is not present in regions to be welded. As a result the coils deployed in the technique after Blakeley produce fields a small fraction of that required to balance the field produced by the high currents. Without a magnetic workpiece there is no predefined orientation to the magnetic field. The technique after Abdurachmanov would require very high opposing fields, needing very high currents to be dynamically controlled very quickly to prevent arc extinction. The high fields required to overcome the field from the smelting conductor will require many turns in order to operate at a reasonable current and this results in high coil inductance and slow response rendering this technique incapable of tracking and preventing the arc blow.

### SUMMARY OF THE INVENTION

The present invention provides apparatus for reducing the magnetic field in a weld region where an arc weld is to be carried out in the presence of an ambient magnetic field, comprising:
a magnetic field generator for generating an opposing magnetic field in the weld region in response to an input current;
a magnetic field sensor for sensing the direction and the magnitude of an ambient magnetic field in any vector direction in the weld region and outputting a sensor signal in response thereto; and
a controller arranged to receive the sensor signal and control the input current to the magnetic field generator in response to the sensor signal so as to generate the opposing magnetic field which reduces the magnetic field in the weld region.

Apparatus embodying the invention enables a low magnetic field zone to be formed in a weld region by reducing and preferably substantially balancing or minimising the ambient field in any vector direction so that a more reliable and better quality weld can be formed. The apparatus is particularly suitable for use in high magnetic field environments generated by non-magnetic bars carrying high electrical currents.

Reference herein to a magnetic field sensor for sensing the direction and the magnitude of an ambient magnetic field in any vector direction indicates a sensor able to output a sensor signal from which the direction and magnitude of the magnetic field can be determined, whatever the direction of the field in three-dimensional space. The sensor may comprise three orthogonally positional magnetic field sensors, for example three Hall effect devices.

In many environments where welding is required, the geometry of the conductors around the weld region and the weld path determine the direction of the ambient magnetic field at each stage of the weld. In many cases, it is not possible to remove the ambient magnetic field. In order to evaluate the field that is to be balanced, sensing of both the magnitude and direction of the magnetic field is required in a manner sensitive to all directions of field. This may be achieved by a magnetic field sensor measuring magnetic field in three orthogonal directions, with the resultant magnetic field magnitude and direction calculated within the controller in response to the sensor signal received from the sensor.

Preferably, the magnetic field generator comprises a core formed of magnetic material, and at least one coil located around the core. The core may be formed of steel for example. The core may comprise a pair of opposing pole pieces, with the opposing magnetic field being formed between the pole pieces. In embodiments, the pole pieces may be removable so that different pole piece configurations can be employed.

Preferably, the controller is arranged to control the input current to the magnetic field generator so as to generate an opposing magnetic field which reduces the magnetic field in the weld region to less than a predetermined threshold. This threshold may be 0.005 T for example.

In one preferred implementation of the present apparatus, the core of the magnetic field generator defines an incomplete loop with a pole piece at each end. The opposing magnetic field is formed between the pole pieces. Thus, the generator defines an open magnetic circuit.

In use, the magnetic field generator may be orientated such that the direction of the ambient field is orthogonal to the faces of the pole pieces. The controller adjusts the current supplied to the coil or coils of the magnetic field generator from the power supply, so that the field produced between the poles substantially balances the ambient magnetic field.

The magnetic pole pieces of the generator may be interchangeable, with the pole piece configuration being selected depending on the local field direction, the direction of the weld path, and the available physical access to the weld region. For example, each pole piece may be elongated in a direction substantially perpendicular to the opposing magnetic field generated by the magnetic field generator.

In cases where it is impractical to orientate the pole pieces so that the direction of the field is orthogonal to the pole piece faces, additional magnetic material may be introduced asymmetrically with respect to the pole pieces. This may allow some control of the direction of the opposing magnetic field in out-of-plane directions.

In a second preferred implementation of the present apparatus, the magnetic field generator forms at least two closed magnetic circuits. Preferably, each circuit extends via the at least one coil and the weld region is defined between the circuits, within one of the circuits.

According to a further aspect of the present invention, a magnetic field generator is provided for generating an opposing magnetic field in a weld region in response to an input current, comprising:
a core formed of magnetic material; and
at least one coil around the core for receiving the input current,
wherein the magnetic field generator forms two closed magnetic circuits, with each circuit extending via the at least one coil, and with the weld region defined between the circuits and within one of the circuits.

In embodiments, two openings or regions may be enclosed by the magnetic material of the magnetic field generator, with the regions sharing a common boundary. One region defines the welding region and the magnetic material surrounding that region provides magnetic shielding from an ambient magnetic field. The coil or coils are disposed around the magnetic material forming the boundary of the other region.

The coil or coils are used to control the magnetic flux levels in the boundary of the weld region, via the two magnetic circuits. The flux generated in the boundary of the weld region counters flux generated by the ambient magnetic field in the boundary. This reduces the reluctance of the magnetic material in the boundary, leading to more of the ambient magnetic field being drawn out of the weld region and into the surrounding magnetic material, thereby increasing the efficacy of the magnetic shielding it provides.

The geometry of the regions defined by the magnetic field generator core may be selected to suit the orientation of a welding path in relation to the ambient field direction. For example, the magnetic field generator may define an elongate opening for location over and in alignment with a weld path in use. In one embodiment, the elongate opening is elongated in a direction substantially perpendicular to the opposing magnetic field generated by the magnetic field generator. Alternatively, the opening may be elongated in a direction substantially parallel to the opposing magnetic field. In each case, the axis of elongation of the opening is aligned with the weld path.

In a preferred embodiment, the elongate opening is a rectangle, where the long axis of the rectangle is aligned with the welding path. In a case where the welding is parallel to the ambient field direction, the magnetic material defining the rectangle joins the remainder of the magnetic field generator along a longer side of the rectangle. For cases where the welding and magnetic field directions are orthogonal, it is joined along a shorter side of the rectangle.

The magnetic field generator is preferably configured to facilitate ready access to and visibility of the weld region. The generator may define a back plane for engagement with a workpiece to be welded. The end faces of the pole pieces may be disposed adjacent to the back plane such that the opposing magnetic field is generated close to the workpiece. Furthermore, positioning the pole piece faces closer to the side of the magnetic field generator defining the back plane allows the pole pieces to be shaped to facilitate greater access to and visibility of the weld region. In a preferred configuration, each pole piece comprises a tapered or chamfered portion configured such that the thickness of the pole piece measured perpendicular to the back plane increases with distance from the weld region.

The core may define a pair of limbs which extend away from respective pole pieces. Each limb may extend away from the respective pole piece in a direction substantially parallel to the back plane. This reduces the extent to which the limbs may impede the access of a welder to the weld region.

The core may include a back portion which extends between the limbs in a direction substantially parallel to the opposing magnetic field. This back portion preferably has a greater transverse cross-section than the limbs so as to be able to accommodate both the ambient and opposing magnetic fields without magnetically saturating the material.

According to further embodiments, the apparatus may include a pair of side extensions which are magnetically separate from the core. They are arranged in use so as to extend substantially perpendicular to the back plane of the magnetic field generator and substantially parallel to the opposing magnetic field. They may be provided on respective sides of the weld region at locations spaced laterally therefrom in a direction perpendicular to that in which the opposing magnetic field is generated. The side extensions act to draw ambient magnetic field in a direction not parallel to the back plane of the magnetic field generator away from the weld region. This enhances the ability of the generator to shield the weld region with respect to ambient magnetic field in a direction outside the plane of the opposing magnetic field.

Preferably, a portion of each of the side extensions extends in use substantially parallel to the opposing magnetic field direction for at least the length of the weld regions defined by the core, and the portions are arranged in lateral alignment with the weld region between them.

In embodiments where the magnetic field generator defines an opening (or weld region) for location over a weld path in use, a gap may be defined in the portion of the core surrounding the opening, with the faces of the core on either side of the gap separated by non-magnetic material (which may be a solid or air for example) located in the gap. It has been found that provision of such a gap may improve the linearity and uniformity of the opposing magnetic field in the weld region. This therefore improves the stability of a weld arc and improves the effectiveness of the shielding afforded by the magnetic field generator.

In one implementation, the gap extends in a plane substantially parallel to the back plane of the magnetic field generator. Alternatively, or in addition, a gap may be provided which extends in a plane substantially perpendicular to the back plane. Furthermore, a plurality of gaps may be defined. The or each gap may have parallel sides or the sides may be at an angle to each other, defining a wedged-shaped gap. Where there are multiple gaps, they may be arranged substantially parallel to each other, for example.

Current flow through the coil or coils of the magnetic field generator will produce significant amounts of heat. To avoid damage to the coil(s), they may be actively cooled. The temperature may be monitored using an appropriate sensor. The controller may be arranged to calculate a measure of the temperature of the coil with reference to the input current to the coil and the voltage across it. Using a mathematical model of the thermal properties of the magnetic field generator, the controller may be configured to predict the operating time at a particular drive current that remains prior to a predetermined temperature threshold being reached.

The input current supplied to the magnetic field generator may be derived from a dedicated power supply. Alternatively, the apparatus may be arranged to receive the input current from a source available at the installation where the apparatus is to be used.

The present invention further provides a method for reducing the magnetic field in a weld region where an arc weld is to be carried out in the presence of an ambient magnetic field, comprising the steps of:
sensing the direction and the magnitude of an ambient magnetic field in any vector direction in a weld region with a magnetic field sensor;
outputting a sensor signal from the magnetic field sensor in response thereto;
receiving the sensor signal in a controller; and
controlling a magnetic field generator with the controller in response to the sensor signal so as to generate an opposing magnetic field in the weld region which reduces the magnetic field in the weld region.

For example, the ambient magnetic field may be sensed and then the generator controlled so as to generate an opposing magnetic field in the weld region without moving the magnetic field generator.

Alternatively, the sensing and outputting steps may comprise:
moving the magnetic field generator from one weld region to another along a predetermined weld path, with the generator positioned to generate the opposing magnetic field over the weld path at each weld region (without being energised); and
sensing the direction and the magnitude of the ambient magnetic field in any vector direction at each weld region with a magnetic field sensor and outputting sensor signals from the magnetic field sensor to the controller in response thereto,
and the controlling step comprises:
repeating the movement of the magnetic field generator along the predetermined weld path; and
controlling the magnetic field generator with the controller in response to the sensor signals so as to generate an opposing magnetic field at each weld region which reduces the magnetic field in each weld region.

The controlling step may include determining an orientation for the magnetic field generator at each weld region in response to the sensor signals such that the direction of the opposing magnetic field is substantially opposite to that of the ambient magnetic field.

The sensing step may include receiving position signals at the controller related to the position of the magnetic field generator at each weld region. These signals may be generated by an accelerometer carried by the magnetic field generator, for example.

The controller may be configured to divide a weld path into a series of weld regions and the magnetic field generator is then moved from one location to the next along the weld path with a welding operation carried out at each location.

Thus, the magnetic field profile along a weld path may be measured by the magnetic field sensor, with the controller recording magnitude and direction at particular positions. The weld path may be divided into sections intelligently by the controller based on the stored magnetic field measurements. The orientation of and drive current to the magnetic field generator are determined for each section by the controller. The section lengths are determined by the geometry of the pole pieces. Once a section of the weld is completed, the magnetic field generator may be translated, a new tilt set, and the controller then determines and applies a new drive current. Preferably, the magnetic field generator is translated along the weld path so that the weld position remains in substantially the same orientation relative to the pole pieces.

### BRIEF DESCRIPTION OF THE DRAWINGS

Embodiments of the invention will now be described by way of example and with reference to accompany schematic drawings, wherein:

FIG. 1 illustrates the magnetic field generated around a current-carrying bar;

FIG. 2 is a block diagram representing an apparatus embodying the present invention;

FIGS. 3 and 4 are perspective views of two magnetic field generators for use in apparatus embodying the invention;

FIGS. 5 and 6 are perspective views of the magnetic field generators of FIGS. 3 and 4, respectively, when deployed on current-carrying bars;

FIG. 7 is a perspective view of the magnetic field generator of FIG. 3 with a magnetic field sensor mounted thereon;

FIG. 8 is a perspective view of a magnetic field generator forming part of an apparatus embodying the invention, in combination with a pair of side extensions, when deployed on a current-carrying bar;

FIGS. 9 to 11 are perspective, plan and side views respectively of a magnetic field generator similar to that of FIG. 8, but in combination with a different configuration of side extensions;

FIGS. 12 and 13 are perspective views of parts of a magnetic field generator having different formations of gaps around the weld region;

FIG. 14 is a perspective view of another magnetic field generator for use in an apparatus embodying the invention;

FIG. 15 is a perspective view of an alternative pair of pole pieces for use in combination with the magnetic field generator of FIG. 14;

FIG. 16 is a perspective view of the magnetic field generator of FIG. 14 with a magnetic field sensor and accelerometers mounted thereon; and

FIGS. 17 to 19 are perspective views of welding paths parallel to the electric current in a bar, orthogonal to the electric current in a bar, and in the vicinity of two bars carrying current in orthogonal directions, respectively.

### DETAILED DESCRIPTION OF THE DRAWINGS

Current flowing in a conductor generates a proportionate magnetic field. There are industrial applications such as smelting where the current flowing is very high resulting in a very high magnetic field.

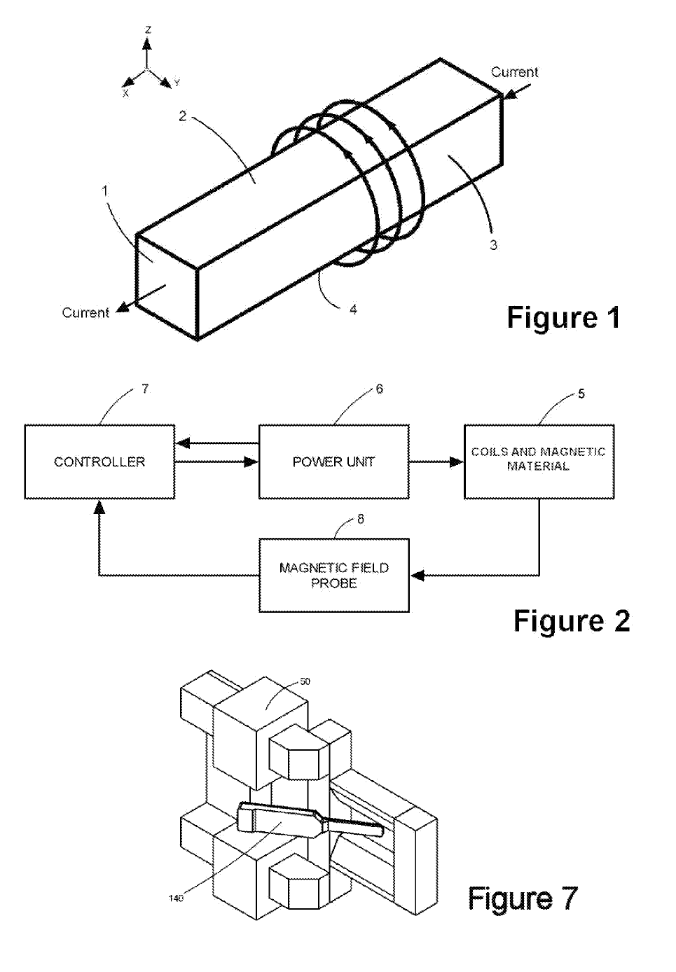

In FIG. 1 an electrical current of 350,000 Amps is flowing in the x-direction through a cross section 1 of 0.64 m². As a result of this current, the magnetic field on surface 2 is −0.15 Tesla in the y-direction and similarly surface 3 will have a magnetic field of 0.15 Tesla in the z-direction. The magnitude and direction of the magnetic field becomes more complex at corners 4, when bars are not linear and in regions where two or more bars are in close vicinity. In smelting and electrolysis applications it is necessary to undertake welding repair work on and close to these electrical conductors while the high currents are flowing. The high magnetic fields result in deflection of the charged particles in the weld arc making such work difficult and the quality of welding very poor. The invention is used to reduce the magnetic field making high quality welds possible.

FIG. 2 illustrates the major sub-assemblies of a system embodying the invention. A low field environment is achieved using coils and magnetic material 5. A power unit 6 supplies current to the coils. The current supplied by the power unit 6 is determined by a controlling voltage, derived from a feedback signal or digital number formulated in the controller 7. Signals indicating the actual current supplied to the coils and magnetic material 5 and the voltage to drive that current are supplied to the controller 7 as proportional voltages or digital numbers.

A magnetic field sensor or probe 8 comprising three orthogonally mounted magnetic field sensors, for example Hall effect devices, facilitates measurement of magnetic field in any direction. The sensor provides three orthogonal magnetic field measurements to controller 7. The controller 7 is able to convert the electrical signals to a form that allows the magnitude and direction of the magnetic field to be determined in the controller. The controller 7 is then used to calculate the required current supplied to the coils 5 to minimise the magnetic field in the weld region.

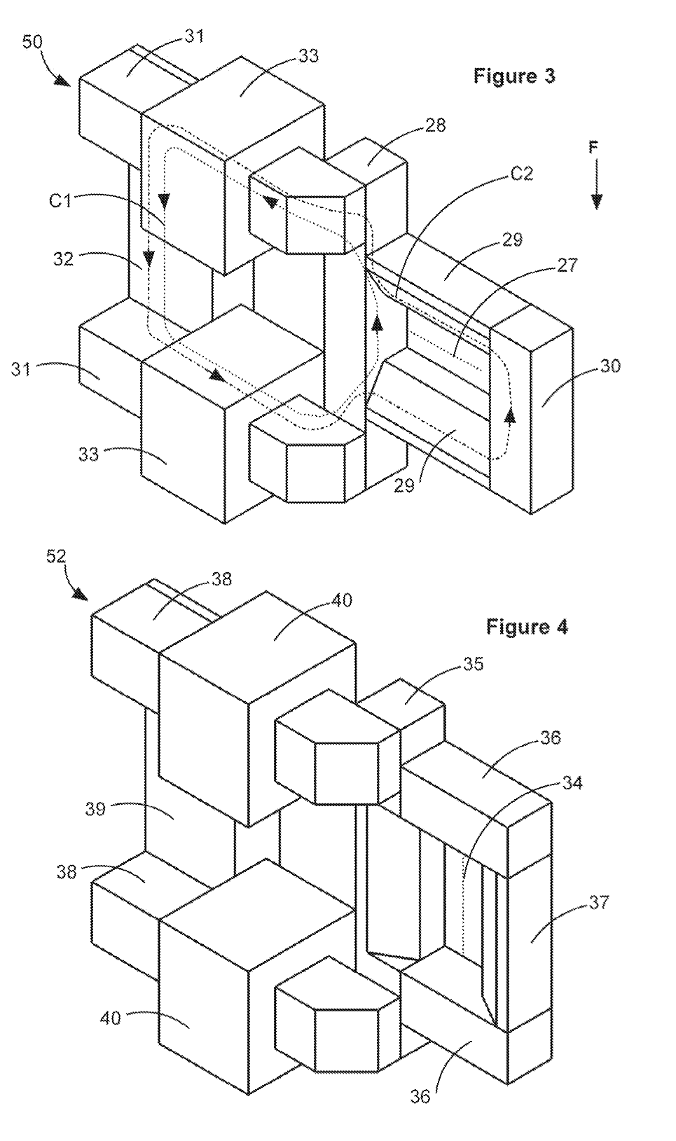

FIG. 3 illustrates a preferred embodiment of a magnetic field generator 50. It has a core of magnetic material which defines closed magnetic circuits and is configured for the case where the welding path 27 is orthogonal to the local ambient field direction. The magnetic material forms two magnetic loops with a common part 28. The loop defining an area around the welding path 27 comprises parts 28, 29 and 30 made of magnetic material, for example of steel. Parts 29 are chamfered to afford good access and visibility for the welder. The other loop comprises parts 28, 31 and 32 made of magnetic material, for example of steel. Coils 33 are wound on magnetic parts (or limbs) 31 and these are joined by the back part 32. Part 32 is larger in cross-section to ensure that saturation does not occur and that the coils can generate magnetic flux effectively in the magnetic circuit and particularly in the loop formed by parts 28, 29,30.

By way of illustration, two magnetic circuits, C1 and C2 are marked on FIG. 3, with a dashed line indicating circuit C1 and a dotted and dashed line marking circuit C2. Arrowheads are used to indicate the direction of the magnetic flux flowing around each circuit when an opposing magnetic field is generated to counter an ambient field in the direction marked F on the Figure.

FIG. 4 illustrates a magnetic field generator 52 defining closed-magnetic circuits and is configured for the case where the welding path 34 is parallel to the local ambient field direction. The magnetic material forms two magnetic loops with a common part 35. The loop defining the area around the welding path comprises parts 35, 36 and 37 made of magnetic material, for example of steel. Parts 35 and 37 are chamfered to afford good access and visibility for the welder. The other loop comprises parts 35, 38 and 39 made of magnetic material, for example of steel. Coils 40 are wound on magnetic parts 38 and these are joined by the back part 39. Part 39 is larger in cross-section to ensure that saturation does not occur and that the coils can generate magnetic flux effectively in the magnetic circuit and particularly in the loop formed by parts 35, 36, 37.

FIG. 5 illustrates deployment of the embodiment of FIG. 3 for weld path 41 that is parallel to the current flow through a cross-section 42 of bar 43. The weld path 41 is nominally orthogonal to the direction of the magnetic field. The magnetic field generator defines a back plane which engages the planar upper surface of bar 43.

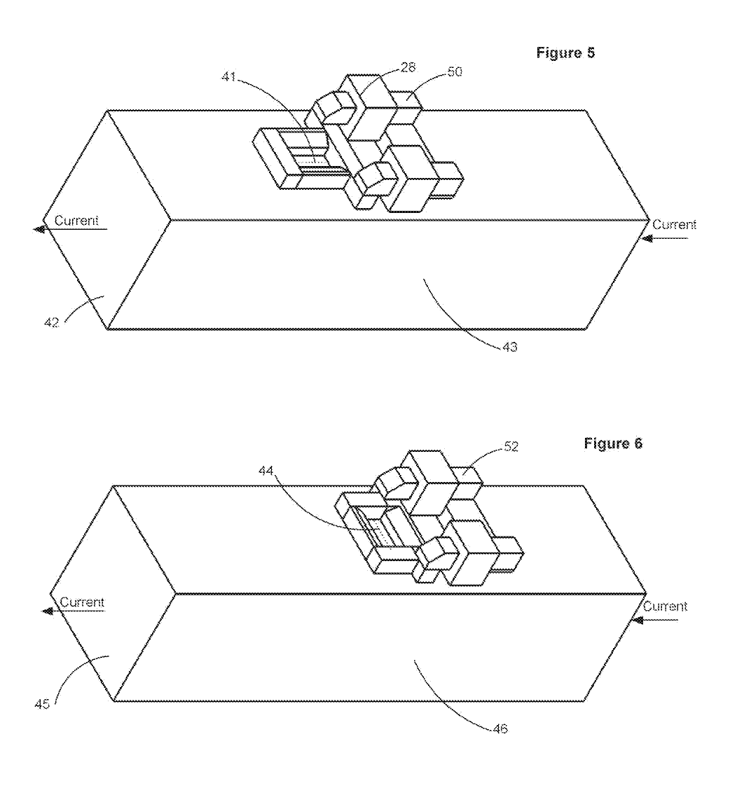

FIG. 6 illustrates deployment of the embodiment of FIG. 4 for weld path 44 that is orthogonal to the current flow through a cross-section 45 of bar 46. The weld path 44 is nominally parallel to the direction of the magnetic field. The magnetic field generator defines a back plane which engages the planar upper surface of bar 46.

The configurations shown in FIGS. 5 and 6 can be extended to more complex ambient fields where the vector of the field is not parallel or orthogonal to the weld path. In these cases the orientation of the selected embodiment is chosen to minimise the field along the weld path.

The core may be formed from layers cut from sheet steel which are built up to give the required thickness of material. The transverse cross-sections of the elements of the core need to be large enough to ensure that magnetic saturation does not occur in a given working environment. The cross-section needs to be greater where the magnetic field generated by the magnetic field generator and the ambient magnetic field are in substantially the same direction.

FIG. 7 shows a Hall sensor 140 removably mounted in position on a magnetic field generator of the configuration shown in FIG. 3.

According to one method of using magnetic field generators of the form shown in FIGS. 3 to 7, the generator is located on the current-carrying conductor in an appropriate orientation as shown in FIG. 5 or 6 for example. The direction and magnitude of the magnetic field in the weld region is then sensed using magnetic field sensor 140. The sensor can then be removed and an appropriate input current fed to the magnetic field generator so that it generates a field which substantially balances or sufficiently minimises the resultant magnetic field in the weld region to enable a weld to be reliably formed along the weld path. If necessary, the magnetic field generator can then be moved along the weld path to enclose another section in its weld region and the process repeated.

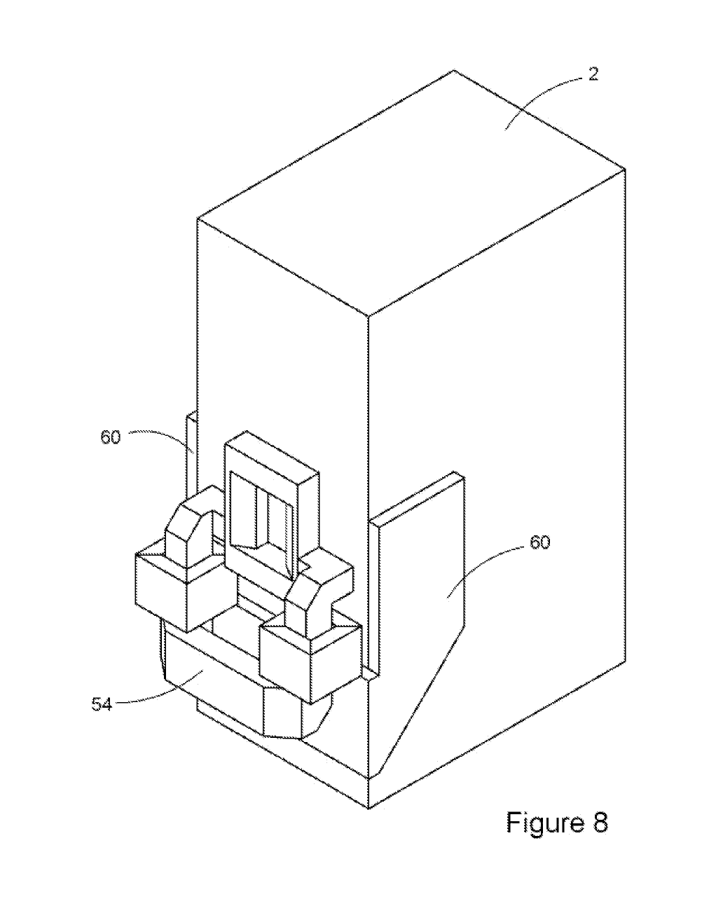

FIG. 8 shows a magnetic field generator 54 (having a configuration similar to that of the generator shown in FIG. 3) in combination with a pair of side extensions 60. The side extensions are formed from magnetic material which is spaced apart from (so as to be magnetically separate from) the magnetic material of the generator 54.

The side extensions 60 are provided to preferentially attract magnetic field in a direction approximately perpendicular to the back plane of the generator 54. This has the effect of reducing the field in the weld region and also reduces the field that is induced in the magnetic components of the generator 54 by the ambient magnetic field. Accordingly, the side extensions serve to enhance the shielding effect of the magnetic field generator and further reduce the resultant field in the weld region.

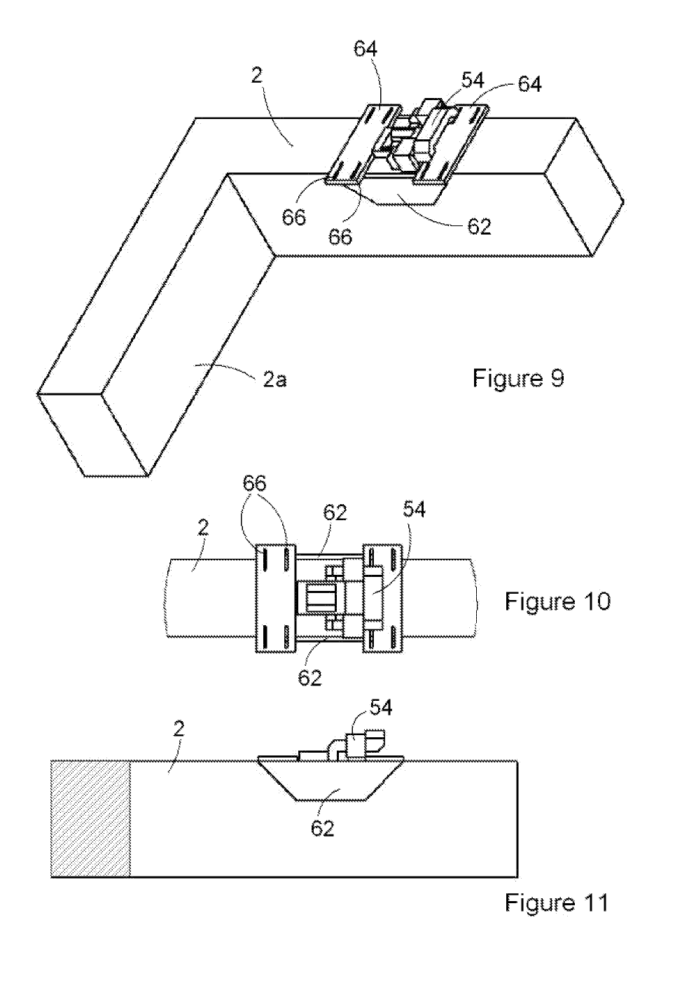

The magnetic field orthogonal to the back plane of the generator 54 may for example arise from another busbar not shown in FIG. 8. Such a scenario is illustrated in relation to the embodiments of FIGS. 9 to 11. In the arrangement shown in FIG. 9, the conductor 2 includes portion 2a which extends at right-angles from one end of the conductor portion on which the generator 54 is located. It can be seen that conductor 2a will generate magnetic flux which is approximately perpendicular to the back plane of generator 54.

The side extensions 62 of the embodiment depicted in FIGS. 9 to 11 have a different configuration to extensions 60 of FIG. 8. The side extensions 62 are coupled together at each end by coupling elements 64 which extend parallel to the back plane of the generator 54. Side extensions 62 and coupling plates 64 are magnetically separate from the generator 54. The side extensions 62 are coupled to the coupling plate 64 via a series of slots 66 which extend perpendicular to the plane of the side extensions and the longitudinal axis of the conductor. The side extensions are coupled to the coupling plate so as to facilitate adjustment of the lateral spacing of the side extensions to accommodate different widths of conductor.

To effectively draw magnetic flux away from the weld region, the side extensions should preferably extend longitudinally along the conductor at least for the length of the weld region. Their dimensions and geometry are selected such that they do not become magnetically saturated in a given working environment.

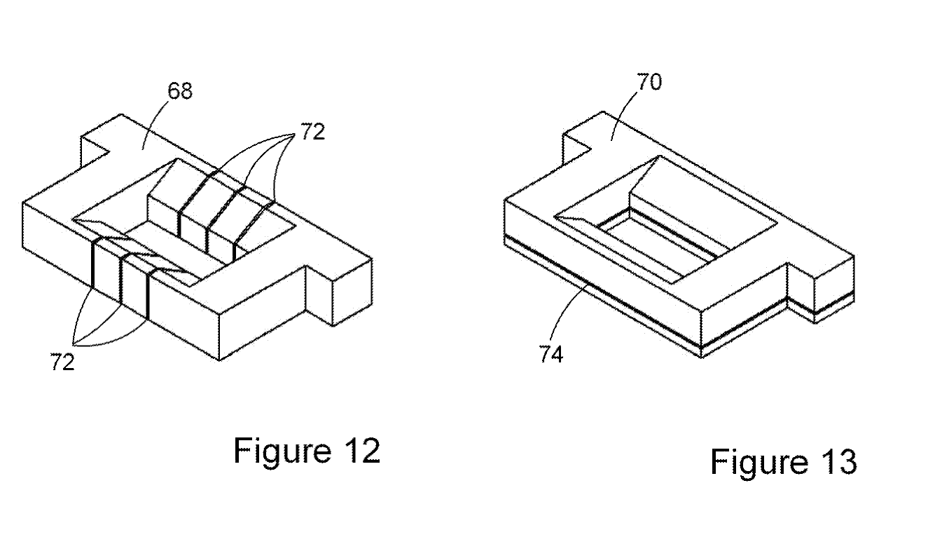

FIGS. 12 and 13 depict further embodiments of part of a magnetic field generator for use in apparatus embodying the invention. The parts 68 and 70 shown in the Figures are formed of magnetic material and serve in use to surround and shield the weld region. In each case, one or more gaps are formed in the magnetic material. In the embodiment of FIG. 12, gaps 72 extend in a plane perpendicular to the back plane of the generator and also perpendicular to the direction in which the opposing magnetic field is predominantly generated. Three gaps are provided at equally spaced locations along two opposing sides of the weld region.

In the embodiment of FIG. 13, gap 74 extends in a plane parallel to the back plane of a generator.

The gaps may be voids filled by the ambient atmosphere. Alternatively, a layer of solid non-magnetic material may be provided in each gap to space apart the adjacent portions of magnetic material. The breaks in the magnetic circuit formed by the gaps serve to improve the linearity and uniformity of the opposing magnetic field generated in the weld region by the magnetic field generator. The presence of a more uniform field assists the welder as the behaviour of the arc is then more predictable along the weld path. It also improves the effectiveness of the shielding affected by the coils of the generator. Magnetic flux effectively bulges out around the gaps which may assist by countering ambient magnetic field in directions outside the plane of the generator. The portions of the magnetic material separated by the gaps may be held in position for example by clamping them to a non-magnetic support plate, or by joining them together using non-magnetic connectors.

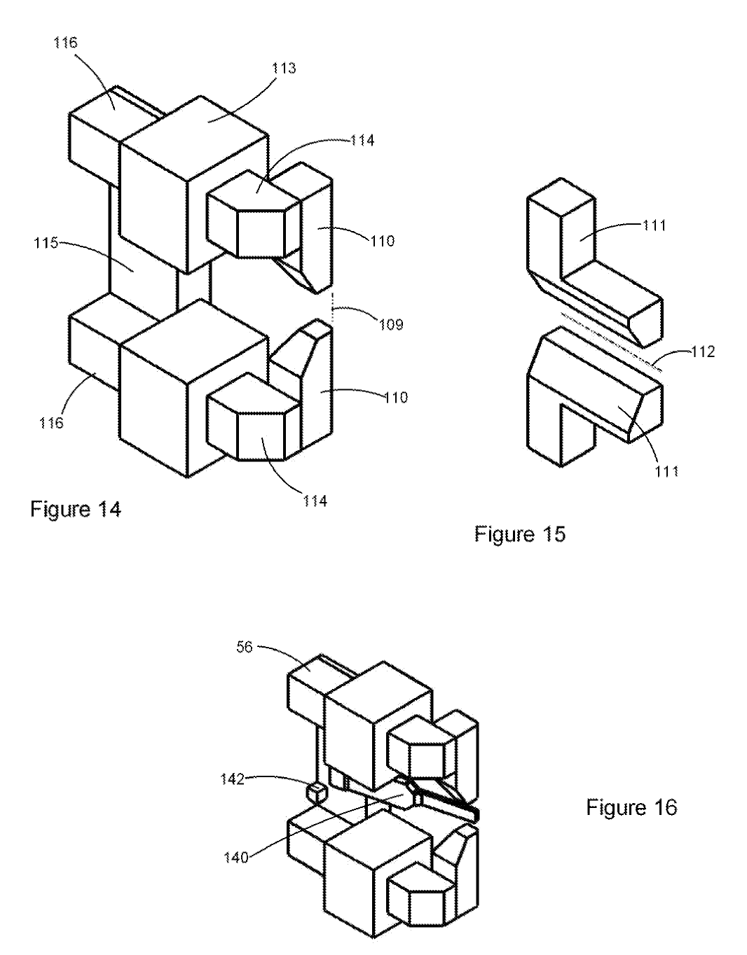

FIGS. 14 to 16 illustrate a preferred embodiment of a magnetic field generator 56 defining an open magnetic circuit. The welding region 109 is defined by the magnetic pole pieces 110. Pole pieces are interchangeable and pole pieces 110 are designed for restricted corner welding while poles pieces 111 offer a longer linear welding path 112. Two coils 113 are wound on upper and lower magnetic cores 114. A back part 115 of magnetic material of the back of the generator has larger cross-section to ensure magnetic saturation does not occur. The compact core made of back part 115, cores 114 and pole pieces 110 maximises magnetic efficiency and maintains good access and visibility to the welding region 109. A magnetic field sensor or probe 140 (see FIG. 16) clips into position on the back part 115 so that the active area is in the welding region 109. During welding the probe 140 is removed from the welding region 109 to allow maximum access and visibility to the welder.

Resistive heating in the coils will cause the temperature of the coils and core to rise. This is mitigated to some extent by air cooling devices (not shown) on surface 116. The average temperature in the coils is monitored by the controller 7 and the current drive to the generator is switched to zero if overheat is detected. The preferred method of monitoring the temperature is to monitor the drive voltage supplied to the coils at a particular current. The temperature can be measured directly but in the present embodiment it is calculated in the controller from knowledge of the thermal response of the resistivity of the coil metal windings and the measured resistance. Algorithms in the controller are used to calculate an estimate of the time that the system can be operated at the particular drive current before an excessive temperature is reached. Mathematical modeling of the thermal response of the system is used to derive these algorithms.

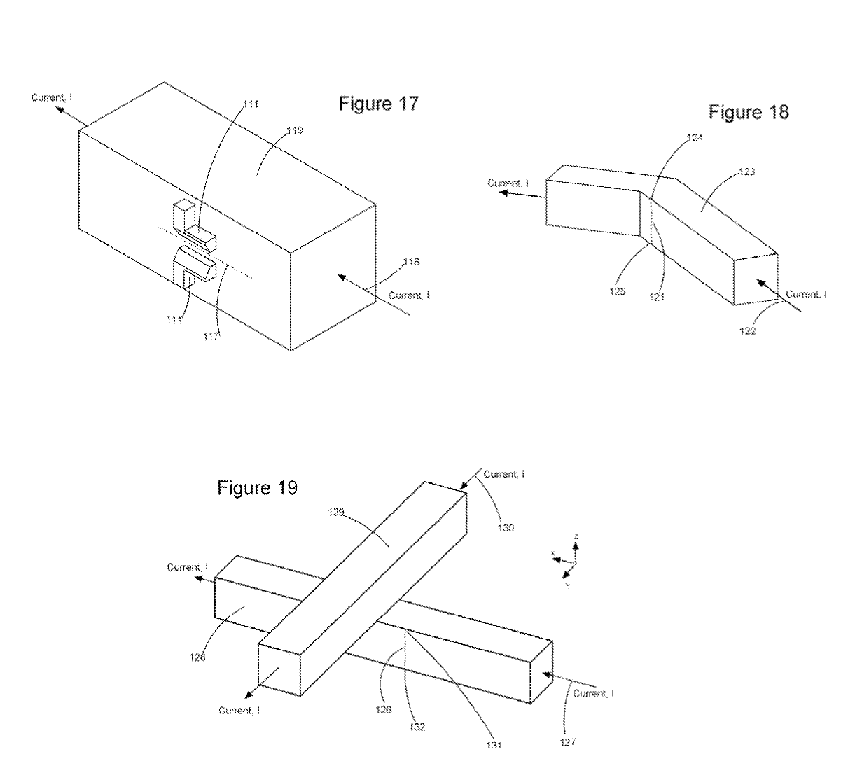

Welding repairs typically follow a linear path and this path can be in any orientation relative to the local direction of the magnetic field from the bar. FIG. 17 illustrates a case where the welding path 117 is in the direction of the current 118 flowing through the bar 119 and orthogonal to the local field direction. Extended poles 111 are used and the field can be counterbalanced over the majority of the welding path 117. On completion of the weld, the magnetic field generator (not shown) would be translated if the path extends outside of the pole pieces or if it is necessary to undertake further welds in this orientation.

FIG. 18 illustrates a welding path 121 that is orthogonal to the current flow 122 through the bar 123 and in the direction of the magnetic field. Here the magnetic field generator must be translated in the direction of the weld path 121 as the weld progresses so that the weld position stays centrally between the pole pieces. Shaped compact pole pieces 110 in FIG. 14 are appropriate in this case to maximise the magnetic effect.

Depending on the local geometry and current flow the magnetic field can change over the welding path. To address this, the system controller has a learn facility and the magnetic field generator is fitted with accelerometers 142 (see FIG. 16). The accelerometer signals are twice integrated to provide position information. During the learn sequence, the magnetic field generator is translated along the weld path with the probe in the welding position and the measured magnetic field, magnitude and direction are recorded as a function of position as determined by the accelerometers. In FIG. 18, at the start 124 and end 125 of the welding path 121 the controller determines the current settings to minimise the measured magnetic fields. Based on this information the controller determines the current drive settings required to counterbalance the magnetic field at set positions along the path. The Hall probe 140 is then removed and the controller minimises the magnetic field as the weld progresses along the path.

FIG. 19 illustrates a welding path 126 where the orientation of the field varies along the path. The electrical current 127 flowing in the x-direction in the lower bar 128 will produce a magnetic field in the z-direction at the weld path. A second bar 129, physically detached from the first, carries electrical current 130 in the y-direction. This current produces magnetic field on the welding path 126 that has a significant component in the x-direction. The magnitude of this x-component of magnetic field is significantly larger at the start of the path 131 than it is at the end of the path 132. The resultant field varies along the weld path 126 in both magnitude and direction.

The magnetic field generator is traversed across the weld path 126 and the magnitude and direction of the magnetic field recorded as a function of position along the path. The process used is to split the weld path into sections determined by the size of the pole pieces. Using the field data the controller calculates a tilt value for the electromagnet and a drive current for each section. The choice of section length and values is optimised such that the magnetic field at all positions along the section is sufficiently small to facilitate welding, the target magnitude being less than 0.005 Tesla. For each section the back plane of the magnetic field generator is oriented parallel to the xz plane, at an angle as defined by the controller. Measurement of the angle can be achieved using a simple spirit level or on the controller by clipping in the 3-axis magnetic probe and checking that the ambient field direction is opposite to the direction in which the opposing magnetic field will be generated. Welding can then proceed along the section whilst the input current is controlled as a function of position. Once a section is complete the controller will audibly warn the welder to stop. A new tilt is then set for the next section and the process repeats.

In cases where tilting is not practical counterbalancing in the plane can be achieved by changing the pole piece arrangement. By adding an addition pole piece, a vector component of the nulling field is produced in a direction that does not correspond to the line between the pole pieces. This local distortion of the field can be controlled either by the position of the additional pole piece or by additional coils mounted on it.

Apparatus embodying the invention may be provided with its own dedicated power supply. Alternatively, it may be arranged to draw current to feed to the magnetic field generator from a source available at the installation where the apparatus is to be used. For example, in an aluminium smelting plant, a series of smelting pots may be connected together in series, with a voltage drop across each pot. An appropriate voltage for the magnetic field generator may be tapped off from appropriate points along this arrangement. The source may be mains power, batteries or the voltage on the pots. Control of the current from the source may be achieved directly with the mains power or with a pulse width modulation technique switching power (smoothed with a capacitor) into the supply circuit for the coil(s) of the magnetic field generator. The pulse duty cycle would be modulated to keep the current in the coil(s) at the required set point.

1. Apparatus for reducing the magnetic field in a weld region where an arc weld is to be carried out in the presence of an ambient magnetic field, comprising:
a magnetic field generator for generating an opposing magnetic field in the weld region in response to an input current;
a magnetic field sensor for sensing the direction and the magnitude of an ambient magnetic field in any vector direction in the weld region and outputting a sensor signal in response thereto; and
a controller arranged to receive the sensor signal and control the input current to the magnetic field generator in response to the sensor signal so as to generate the opposing magnetic field which reduces the magnetic field in the weld region.

2. Apparatus of claim 1, wherein the magnetic field generator comprises a core formed of magnetic material, and at least one coil around the core.

3. Apparatus of claim 1, wherein the controller is arranged to control the input current to the magnetic field generator so as to generate an opposing magnetic field which reduces the magnetic field in the weld region to less than a predetermined threshold.

4. Apparatus of claim 3, wherein the controller is arranged to control the input current to the magnetic field generator so as to generate an opposing magnetic field which reduces magnetic field in the weld region to less than 0.005 T.

5. Apparatus of claim 1, wherein the core of the magnetic field generator defines an incomplete loop with a pole piece at each end.

6. Apparatus of claim 5, wherein the core comprises a pair of opposing pole pieces, with the opposing magnetic field being formed between the pole pieces and the pole pieces removable so that different pole piece configurations can be employed.

7. (canceled)

8. Apparatus of claim 1, wherein the magnetic field generator forms two closed magnetic circuits, with each circuit extending via the at least one coil, and with the weld region defined between the circuits and within one of the circuits.

9. A magnetic field generator for generating an opposing magnetic field in a weld region in response to an input current, comprising:
a core formed of magnetic material; and
at least one coil around the core for receiving the input current,
wherein the magnetic field generator forms two closed magnetic circuits, with each circuit extending via the at least one coil, and with the weld region defined between the circuits and within one of the circuits.

10. Magnetic field generator of claim 9, wherein the magnetic field generator defines an elongated opening for location over and in alignment with a weld path in use.

11-12. (canceled)

13. Magnetic field generator of claim 9, wherein the magnetic field generator defines a back plane for engagement with a planar surface on a workpiece to be welded.

14. Magnetic field generator of claim 13, wherein pole pieces define opposing end faces substantially perpendicular to and disposed adjacent to the back plane.

15. Magnetic field generator of claim 13, wherein each pole piece comprises a tapered portion configured such that the thickness of the pole piece measured perpendicular to the back plane increases with distance from the weld region.

16. Magnetic field generator of claim 9, wherein the core defines a pair of limbs which extend away from respective pole pieces, and wherein each of the pair of limbs extends away from the respective pole piece in a direction substantially parallel to the back plane.

17-18. (canceled)

19. Magnetic field generator of claim 16, wherein a respective coil is located around each limb.

20. Magnetic field generator of claim 16, wherein the core includes a back portion which extends between the limbs in a direction substantially parallel to the opposing magnetic field, having a greater transverse cross-section than the limbs so as to accommodate both the ambient and opposing magnetic fields.

21. Apparatus of claim 1, wherein the magnetic field generator defines a back plane for engagement with a planar surface on a workpiece to be welded, and the apparatus includes a pair of side extensions which are magnetically separate from the core, arranged in use so as to extend substantially perpendicular to the back plane and substantially parallel to the opposing magnetic field, and provided on respective sides of the weld region at locations spaced laterally therefrom in a direction perpendicular to the ambient magnetic field.

22. (canceled)

23. Magnetic field generator of claim 9, wherein the magnetic field generator defines an opening for location over a weld path in use, and a gap is defined in the portion of the core surrounding the opening, with the faces of the core on either side of the gap separated by non-magnetic material in the gap.

24-26. (canceled)

27. Apparatus of claim 1, wherein the magnetic field sensor comprises three orthogonally positioned magnetic field sensors.

28. (canceled)

29. Apparatus of claim 2, wherein the controller is arranged to calculate a measure of the temperature of the coil with reference to the input current to the coil and the voltage across it, wherein the controller is arranged to predict when a temperature threshold associated with the coil will be exceeded, and wherein the prediction is calculated with reference to the current temperature of the coil, the input current and a mathematical model of the thermal response of the apparatus.

30-33. (canceled)

34. A method for reducing the magnetic field in a weld region where an arc weld is to be carried out in the presence of an ambient magnetic field, comprising the steps of:
sensing the direction and the magnitude of an ambient magnetic field in any vector direction in a weld region with a magnetic field sensor;
outputting a sensor signal from the magnetic field sensor in response thereto;
receiving the sensor signal in a controller; and
controlling a magnetic field generator with the controller in response to the sensor signal so as to generate an opposing magnetic field in the weld region which reduces the magnetic field in the weld region.

35. Method of claim 34, wherein the magnetic field generator is maintained continuously at substantially the same location during and between the sensing and controlling steps.

36. Method of claim 34, wherein the sensing and outputting steps comprise:
moving the magnetic field generator from one weld region to another along a predetermined weld path, with the generator positioned to generate the opposing magnetic field over the weld path at each weld region; and
sensing the direction and the magnitude of the ambient magnetic field in any vector direction at each weld region with a magnetic field sensor and outputting sensor signals from the magnetic field sensor to the controller in response thereto,
and the controlling step comprises:
repeating the movement of the magnetic field generator along the predetermined weld path; and
controlling the magnetic field generator with the controller in response to the sensor signals so as to generate an opposing magnetic field at each weld region which reduces the magnetic field in each weld region.

37. (canceled)

38. Method of claim 36, wherein the sensing step includes receiving position signals at the controller related to the position of the magnetic field generator at each weld region, wherein the position signals are generated by an accelerometer mounted on the magnetic field generator.

39. (canceled)

40. Method of claim 36, wherein the movement repetition step comprises:
determining with the controller, having regard to the sensor signals, a series of locations along the weld path at which the magnetic field generator should be positioned whilst welding is carried out; and
moving the magnetic field generator from one location to the next along the weld path after each respective welding operation has been carried out.

41-63. (canceled)

64. Apparatus of claim 1, for use in an aluminium smelting plant with a series of smelting pots connected together in series with a voltage drop across each pot, arranged to tap off appropriate voltage for the input current for the magnetic field generator from appropriate points along the series of smelting pots.
